(19) United States
(12) Patent Application Publication
(10) Pub. No.: US 2021/0270397 A1
(43) Pub. Date: Sep. 2, 2021

(54) AEROSPACE HOSE HAVING EPDM RUBBER LAYER

(71) Applicant: Eaton Intelligent Power Limited, Dublin 4 (IE)

(72) Inventors: Aaron David Clark, Lambertville, MI (US); Soumyajit Sarkar, Farmington Hills, MI (US)

(21) Appl. No.: 17/323,690

(22) Filed: May 18, 2021

Related U.S. Application Data
(62) Division of application No. 14/713,771, filed on May 15, 2015.
(60) Provisional application No. 61/994,613, filed on May 16, 2014.
(60) Provisional application No. 61/994,655, filed on May 16, 2014.

(51) Int. Cl. F16L 11/12; F16L 11/08; B32B 27/12; B32B 25/08; B32B 27/32; B32B 25/10; B32B 25/14; B32B 5/02; B32B 27/08; B32B 1/08

(52) U.S. Cl. CPC F16L 11/12; F16L 11/085; B32B 27/12; B32B 25/08; B32B 27/322; F16L 2011/047; B32B 27/32; B32B 25/14; B32B 5/02; B32B 27/08; B32B 1/08; B32B 25/10

(57) ABSTRACT

The present disclosure relates to a hydraulic hose having a first layer that has a composition that includes PTFE. The hydraulic hose also has a second layer for preventing alkyl phosphate ester from permeating through the hydraulic hose to an exterior surface of the hydraulic hose. The second layer has a composition that includes EPDM rubber.

### CROSS-REFERENCES TO RELATED APPLICATIONS

This application claims the benefit of U.S. Provisional Application No. 61/994,613, filed May 16, 2014, and U.S. Provisional Application No. 61/994,655, filed May 16, 2014, the entire contents of each of which is incorporated by reference herein.

### TECHNICAL FIELD

The present disclosure relates generally to hoses used in the aerospace industry. More particularly, the present disclosure relates to hoses in the aerospace industry for carrying fire resistant hydraulic fluids such as alkyl phosphate esters.

### BACKGROUND

Polytetrafluoroethylene (PTFE) hoses are used in the aerospace industry to carry alkyl phosphate ester through a hydraulic circuit that may include hydraulic pumps, hydraulic motors, hydraulic cylinders or other types of actuators. Alkyl phosphate ester is a fire resistant hydraulic fluid commonly used for aerospace applications. It has been determined that PTFE hoses can develop micro-voids at stress locations of the hose. In certain conditions, such micro-voids can allow certain fluids such as alkyl phosphate esters to permeate (e.g., “weep” or “sweat”) through to the exterior surface of the hose. This results in a residue layer forming on the exterior surface of the hose.

### SUMMARY

Aspects of the present disclosure relates to methods and structures for containing alkyl phosphate ester within a PTFE hose such that the alkyl phosphate ester is prevented from permeating to an exterior surface of the hose and generating residue thereon.

Another aspect of the present disclosure relates to a hose for conveying alkyl phosphate ester in aerospace applications. In certain examples, the hose includes a first layer having a composition that includes PTFE and a second layer having a composition that includes ethylene propylene diene monomer rubber (EPDM rubber). In certain examples, the second layer functions as a blocking layer, a containment layer, or a barrier layer for inhibiting alkyl phosphate ester from permeating through the hose to an exterior surface of the hose. In certain examples, the EPDM rubber of the second layer has a low ethylene polymer formulation so as to maintain integrity at temperatures as low as minus 50 degrees C. In certain examples, the EPDM rubber of the second layer has less than 60% ethylene or in the range of 50-60% ethylene. In certain examples, the EPDM rubber of the second layer can maintain its integrity at high temperatures such as temperatures that range up to 150 degrees C. In certain examples, the EPDM rubber material of the second layer can be peroxide cured so as to provide the second layer with resistance to high temperatures, low compression set and resistance to galvanic corrosion.

In certain examples, the hose can have additional layers. For example, the hose can include one or more reinforcing layers that can include material such as Kevlar, fiberglass, polyester fibers or other structures. In certain examples, the additional layers can also include an ultra-high molecular weight polyethylene sheath applied over the second layer to improve adhesion resistance.

A further aspect of the present disclosure relates to an airplane having a fuselage, wings that project outwardly from the fuselage, and a hydraulic system for actuating various components within the airplane. The hydraulic system includes hoses for carrying alkyl phosphate ester within the various hydraulic circuits that may be incorporated within the fuselage or the wings of the airplane. The hose has a construction that includes a first tube forming an inner layer that carries the alkyl phosphate ester. The first tube can include a composition that includes PTFE. In certain examples, the composition of the inner tube includes PTFE as a base polymer and also includes other materials such as fillers, waxes, plasticizers, curing agents or other materials. The hose further includes a barrier layer positioned outside the inner tube. The barrier layer has a composition that includes EPDM rubber. In certain examples, the composition of the barrier layer includes a base polymer of the EPDM rubber having a formulation with less than 60% ethylene.

In some embodiments, a hydraulic hose is provided comprising a first layer having a composition that includes PTFE; and a second layer for preventing alkyl phosphate ester from permeating through the hydraulic hose to an exterior surface of the hydraulic hose, the second layer having a composition that includes EPDM rubber. In some embodiments, the EPDM rubber has a formulation with less than 60% ethylene, or 50-60% ethylene. In some embodiments, the second layer is peroxide cured. In some embodiments, the second layer is positioned outside the first layer and surrounds the first layer. In some embodiments, a hydraulic hose according to the invention further comprises a hose reinforcing layer that includes reinforcing elements. In some embodiments, the hydraulic hose further comprises a hose reinforcing layer that includes reinforcing elements. In some embodiments, the hose reinforcing layer is positioned between the first layer and the second layer. In other embodiments, the second layer is positioned between the first layer and the hose reinforcing layer. In some embodiments, the hydraulic hose according to the invention maintains integrity at temperatures ranging from minus 50 degrees C. to positive 150 degrees C.

In some embodiments, the hydraulic hose comprises a first layer, having a composition that comprises PTFE, comprises an inner conductive layer and an outer tube jacket. In some embodiments, the one or both of the inner conductive layer and the outer tube jacket comprise PTFE and a filler.

In some embodiments, the hydraulic hose according the invention further comprises an additional outer layer having one, two, three, or more plies prepared from a composition comprising an Ultra High Molecular Weight Polyethylene (UHMW).

In some embodiments, a method is provided for preventing alkyl phosphate ester from permeating through a hydraulic hose having a PTFE layer, the method comprising containing alkyl phosphate ester that permeates through the PTFE layer at a location between the PTFE layer and a blocking layer that surrounds the PTFE layer, wherein the blocking layer has a composition that includes EPDM rubber. In some embodiments, the blocking layer is prepared from a composition comprising EPDM rubber of less than 60% ethylene, or 50-60% ethylene. In some embodiments, the blocking layer is peroxide cured.

In some embodiments, an airplane is provided comprising a fuselage and wings that project outwardly from the fuselage; and hydraulic circuits positioned within the fuselage and/or the wings, the hydraulic circuits including hydraulic hoses for conveying alkyl phosphate ester through the hydraulic circuits, the hydraulic hoses including first layers having compositions that include PTFE, and second layers having compositions that include EPDM rubber. In some embodiments, the airplane comprises hydraulic hoses according the embodiments provided.

In some embodiments, a hydraulic hose is provided comprising a first layer having a composition that includes PTFE; and a second layer for preventing alkyl phosphate ester from permeating through the hydraulic hose to an exterior surface of the hydraulic hose, the second layer having a composition that includes EPDM rubber and exhibits one or more of the following properties by ASTM D412 following vulcanization: a) minimum tensile strength of 1300 psi; b) minimum % Elongation of 150%; c) minimum 100% Modulus of 400 psi; and d) Shore A Hardness of 70-80. In some embodiments, the composition of the second layer comprises one or more EPDM polymers in a range of from 20-50 wt %, 25-45 wt %, or 30-40 wt %. In some embodiments, the composition of the second layer comprises an EPDM polymer comprising ethylidene norbornene (ENB) in the range of 5-10 wt %, 6-9 wt % or 7-8 wt %. In some embodiments, the composition of the second layer comprises a filler selected from the group consisting of carbon black, silica, silicates, talc, aluminum silicate, calcium carbonate, zinc oxide, and titanium dioxide. In some embodiments, the composition of the second layer comprises a filler in a range of from 30-60 wt %, 35-55 wt %, or 40-50 wt % compared to the total weight of the composition.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 illustrates an airplane having one or more hydraulic circuits that incorporate hydraulic fluid hoses having constructions in accordance with the principles of the present disclosure;

FIG. 2 illustrates a first hydraulic hose construction in accordance with the principles of the present disclosure; and

FIG. 3 illustrates a second hydraulic hose having a construction in accordance with the principles of the present disclosure.

FIG. 4 illustrates one embodiment of co-extruded PTFE core tube construction.

### DETAILED DESCRIPTION

Various examples will be described in detail with reference to the figures, wherein like reference numbers represent like parts and assemblies throughout the several views. Any examples set forth in this specification are not intended to be limiting and merely set forth some of the many possible variations of the inventive aspects disclosed herein.

Aspects of the present disclosure relate to hydraulic hose constructions compatible with the use of fire resistant hydraulic fluids such as alkyl phosphate esters. In certain examples, the hose constructions can be configured to inhibit or prevent alkyl phosphate esters from permeating (e.g., “weeping” or “sweating”) through the hose to an exterior surface of the hose. In certain examples, the hose construction can include a containment or barrier layer that surrounds an inner tube and made of a material having a composition that includes PTFE. In certain examples, the barrier layer can be made of a material having a composition that includes EPDM rubber. In certain examples, the formulation of the EPDM rubber has less than 60% ethylene. In certain examples, the barrier layer prevents alkyl phosphate ester from weeping or sweating through the hose to an exterior surface of the hose, and is compatible with a wide temperature range. For example, the barrier layer can maintain integrity at temperatures as low as minus 50 degrees C. and as high as 150 degrees C. In certain examples, hydraulic hoses in accordance with the principles of the present disclosure are used in hydraulic circuits incorporated into airplanes.

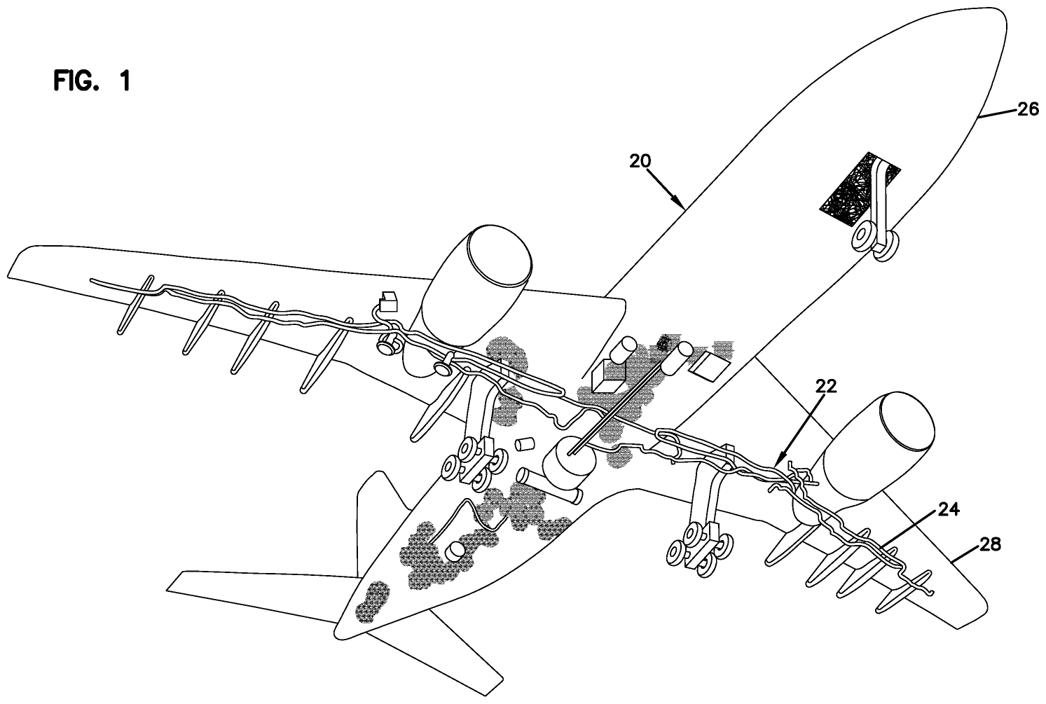

FIG. 1 illustrates an airplane 20 having one or more hydraulic circuits 22 including hydraulic hoses 24 in accordance with the principles of the present disclosure. The airplane 20 includes a fuselage 26 and wings 28. It will be appreciated that the hydraulic circuits 22 can be incorporated into the fuselage 26 and/or the wings 28. In certain examples, the hydraulic circuits 22 can include hydraulic pumps, hydraulic cylinders, hydraulic motors or other actuators used to power various components of the airplane 22. The hydraulic hoses 24 are configured to carry hydraulic fluid in the form of alkyl phosphate ester through the various hydraulic circuits 22. It will be appreciated that the hydraulic hoses 22 have constructions suitable for inhibiting alkyl phosphate ester from permeating through the hoses and forming visible residue layers on exterior surfaces of the hydraulic hoses 24.

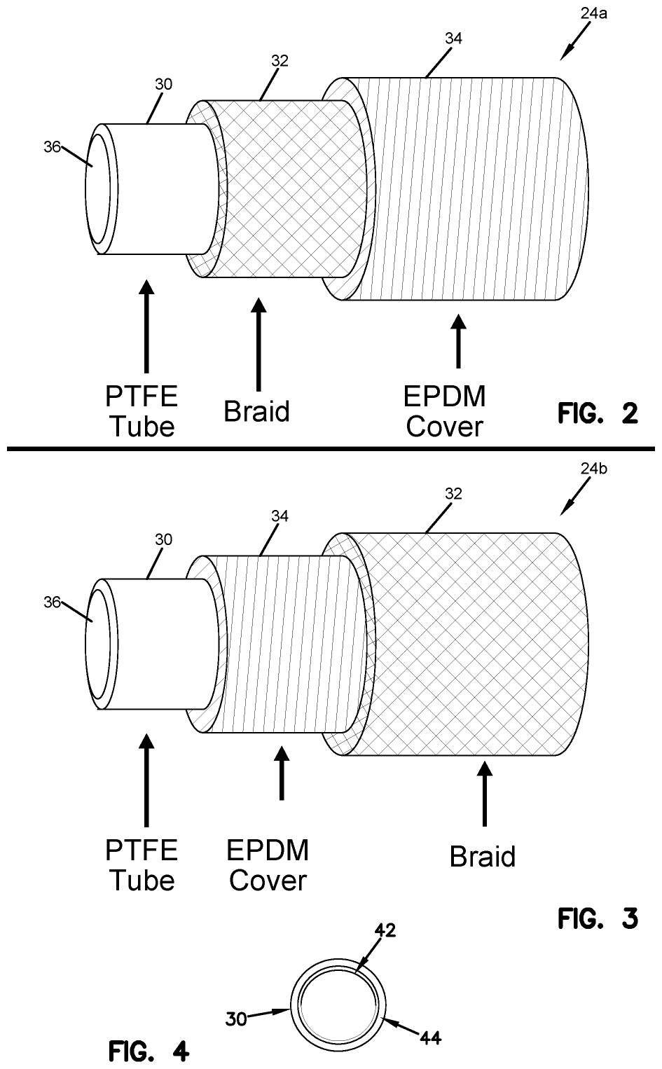

FIG. 2 illustrates a hydraulic hose 24a that can be used in the hydraulic circuits 22 of the airplane 20. The hydraulic hose 24a includes an inner tube 30 made of a material having a composition that includes polytetrafluoroethylene (PTFE). The hydraulic hose 24a also includes a hose reinforcing layer 32 that surrounds the inner tube 30. The hydraulic hose 24a further includes an alkyl phosphate ester permeation blocking layer 34 that surrounds the hose reinforcing layer 32. The blocking layer 34 is alkyl phosphate ester resistant and is configured for preventing alkyl phosphate ester from permeating therethrough. Thus, the blocking layer 34 provides the hydraulic hose 24a with improved fluid containment by containing any alkyl phosphate ester that permeates through the inner tube 30 such that the alkyl phosphate ester is prevented from migrating or permeating to an exterior of the hydraulic hose 24a. Instead, the leaked alkyl phosphate ester is contained between the inner tube 30 and the blocking layer 34.

Referring still to FIG. 2, the inner tube 30 (i.e., a core tube) defines an inner passage 36 through which the alkyl phosphate ester flows during use of the hydraulic hose 24a. The inner tube 34 may include one, two, three or more layers. The inner tube 30 is made of a material having a composition that includes polytetrafluoroethylene (PTFE). In certain examples, PTFE is a base material present in the composition forming the inner tube 30. In certain examples, the composition of the material forming the inner tube 30 can include other additives and materials such as fillers, waxes, curing agents, plasticizers, antioxidants, accelerators, catalysts or other materials.

Still referring to FIG. 2, the hose reinforcing layer 32 is positioned around the exterior of the inner tube 30. In certain examples, the hose reinforcing layer 32 has a construction that provides tensile and/or compressive reinforcement to the hose 24. Additionally, the hose reinforcing layer 32 can enhance the burst strength of the hose 24a. In certain examples, the hose reinforcing layer 32 can include a braid or other arrangement that may include reinforcing fibers, strands, elements or members. In certain examples, the hose reinforcing layer 32 can include reinforcing elements such as yarns, Aramid yarn, polymeric fibers, polymeric strands or other reinforcing elements. In certain examples, hose reinforcing layer 32 can have a braided construction. In certain examples, the reinforcing layer can include a braid that includes polyester or Aramid yarns.

The alkyl phosphate ester permeation blocking layer 34 of the hose 24 is shown as a layer or cover positioned around the exterior of the hose reinforcing layer 32. In one example, the blocking layer 34 is made from a composition that includes ethylene propylene diene monomer rubber (EPDM rubber). EPDM was selected in part because it is compatible with and resistant to aerospace phosphate ester (SKYDROL® aviation hydraulic fluid, Eastman). In certain examples, this rubber includes a saturated chain of polyethylene type. Dienes used in the manufacture of EPDM rubbers include dicyclopentadiene (DCPD), ethylidene norbornene (ENB), and vinyl norbornene (VNB). In some embodiments, the permeation blocking layer 34 includes one, two, three, or more layers.

In certain examples, the EPDM rubber used in the composition of the blocking layer 34 comprises 7-8 wt % ENB by ASTM D 6047. In certain examples, the EPDM rubber used in the composition of the blocking layer 34 exhibits a Mooney Viscosity ML (1+4) at 125° C. of from 55-65 MU by ISO 289. In certain examples, the composition of the blocking layer 34 includes EPDM rubber as a base polymer and also includes a number of other materials such as fillers (e.g., carbon black, silicon, etc.) waxes, curing agents, plasticizers, antioxidants, accelerators or other components. In certain examples, the EPDM rubber used in the composition of the blocking layer 34 has a low ethylene formulation with less than 60% ethylene or in the range of 50-60% ethylene or in the range of 45-55 wt % ethylene by ASTM D 3900. In certain examples, the blocking layer 34 maintains integrity at temperatures ranging from minus 50 degrees C. to positive 150 degrees C. In certain examples, the blocking layer 34 can be applied by extruding the blocking layer 34 over the inner tube 30 and the hose reinforcing layer 32. In other examples, the blocking layer 34 can include a thermal set cover that is wrapped or otherwise placed about the hose reinforcing layer 32 and the inner tube 30. In certain examples, the blocking layer 34 is arranged and configured such that alkyl phosphate ester that permeates through the inner tube 30 is localized (i.e., captured, contained, trapped, blocked, etc.) between the inner tube 30 and the inner surface of the blocking layer 34.

In certain examples, the hydraulic hose 24a can include one or more additional layers. For example, an additional outer layer can be extruded or otherwise applied over the exterior of the blocking layer 34. For example, in one embodiment, an outer cover layer made from a composition including ultra high molecular weight polyethylene can be applied over the blocking layer to form a protective sheath and also to improve adhesion resistance.

FIG. 3 shows another hydraulic hose 24b in accordance with the principles of the present disclosure. Similar to the hydraulic hose 24a, the hydraulic hose 24b is configured for preventing alkyl phosphate ester from permeating through the hose to an exterior surface of the hose. As shown at FIG. 3, the hydraulic hose 24b includes the inner tube 30, the hose reinforcing layer 32 and the blocking layer 34. However, in the embodiment of FIG. 3, the blocking layer 34 is applied (e.g., extruded, wrapped) or otherwise placed directly around the outer surface of the inner tube 30 so as to form an EPDM insulation layer. The hose reinforcing layer 32 is positioned around the exterior of the blocking layer 34. In certain examples, the blocking layer 34 can be bonded to the inner tube 30. In other embodiments, the blocking layer 34 is not bonded to the inner tube 30. In certain examples, the hydraulic hose 24b can include one or more additional layers positioned at different locations within the hydraulic hose 24b (e.g., around the exterior of the hose reinforcing layer 32, between the blocking layer 34 and the hose reinforcing layer 32, or between the blocking layer 34 and the inner tube 30).

FIG. 4 shows one embodiment of the inner tube 30 for use in either hydraulic hose 24a or 24b in accordance with the principles of the present disclosure. FIG. 4 shows inner tube 30 as a two layer co-extruded PTFE tube construction. The inner Tube Liner 42 comprises a Conductive Layer including PTFE T62 and 1-2% carbon black filler. The Tube Jacket 44 includes PTFE T62.

In some embodiments, the EPDM blocking layer 34 is prepared from a composition comprising from 20-50 wt %, 25-45 wt %, or 30-40 wt % of one or more EPDM polymers. In some embodiments, the EPDM is a low ethylene EPDM comprising less than 60 wt % ethylene or in the range of 50-60 wt %, or 45-55 wt % ethylene by ASTM D 3900. In some embodiments, the EPDM comprises a diene in the range of 5-10 wt %, 6-9 wt % or 7-8 wt %. In some embodiments, the EPDM comprises a diene that is ethylidene norbornene (ENB) in the range of 5-10 wt %, 6-9 wt % or 7-8 wt % by ASTM D 6047. In some embodiments, the EPDM exhibits a medium Mooney viscosity in the range of 40-70, 50-70, or 55-65 MU by ISO289. In some embodiments, the EPDM polmer is selected from EPDM (KELTAN® 6750, Lanxess); VISTALON™ 7602 (ExxonMobil); or BUNA® EP G 6850 (Lanxess).

In certain examples, the blocking layer 34 can have a thickness of about 0.002-0.08 inches, 0.01-0.04 inches, or 0.02 inches. Of course, in other examples, other thicknesses can be utilized.

In one embodiment, the EPDM blocking layer material exhibits low compression set. Compression set (C Set) is one of the primary characteristics of a rubber compound directing low temperature sealing capability. EPDM ethylene content is the primary factor influencing this compression effect. As the ethylene content increases, a low-level of crystallinity develops above 55%-65%. If the ethylene/propylene ratio is about equal and the distribution of both monomers in the polymer chain is random then the EPDM is amorphous. Polymers with ethylene content above 60% tend to show high compression set, while the amorphous <60% ethylene materials provide decreased set values at low temperatures. Compression set may be measured according to ISO815 Type A or ASTM D395. In some embodiments, the EPDM blocking layer 34 is prepared from a composition comprising amorphous, low (<60%) ethylene EPDM.

In some embodiments, the EPDM blocking layer 34 is prepared from a composition further comprising one or more antioxidants. Examples of antioxidants used in some embodiments include, for instance, Antioxidant DQ (polymerized 2,2,4-trimethyl-1,2-dihydroquinoline, Akrochem Corp.); Agerite MA™ (2,2,4-trimethyl-1,2-dihydroquinolone polymer) or Irgafos® 168 (tris (2,4-di-tert-butylphenyl)phosphite, Ciba). In some embodiments, the antioxidant is present at about 0.01 wt % to about 5 wt % by weight of the rubber backing layer composition. In other aspects, the antioxidant is present at about 0.05 wt % to about 3 wt %; 0.1 wt % to about 1.5 wt; or from about 0.3 wt % to about 1.0 wt % by weight of the composition.

In some embodiments, cross linking in the EPDM blocking layer composition is controlled by addition of peroxides with or without curing agents, and or coagents, for example, metallic coagents. Cross link density is a measure of the vulcanization properties of a thermoset material such as rubber and is fundamental to creating a useful polymeric article. Cross links can be generated between the carbon backbone and some satellite branches of a polymer using sulfur, peroxide and a variety of coagents and accelerators with a final E-Beam, autoclave (steam) or heat induction vulcanization process step. The actual cross-links are generally sulfur linkages or free radically induced covalent linkages that improve tensile strength, elongation and hardness of the material, resulting in a tougher harder compound. Until cross-linking, the material will have decreased properties and little chemical compatibility. Cross link density is generally measured with a rheometrical instrument (RPA or MDR) or a Dynamic Mechanical Analyzer (DMA) as a measure of torque as the vulcanization process progresses. In some embodiments, the EPDM blocking layer 34 is prepared from a composition further comprising one or more metallic coagents in an amount from 0.1-3 wt %, 0.2-2 wt % or 0.5-1 wt % compared to the total weight of the composition. In some embodiments, the coagent is selected from trifunctional (meth)acrylate ester (TMA), N,N′-m-phenylene dimaleimide, zinc diacrylate, and zinc dimethacrylate. In some embodiments, the coagent is selected from zinc diacrylate, and zinc dimethacrylate. In some embodiments, the curing agent is selected from one or more of triallyl cyanurate (TAC), triallyl isocyanurate, or trimethylolpropane trimethacrylate. In another embodiment, the curing agent includes magnesium oxide. In some embodiments, the composition comprises a curing agent is present in a range from 0.01-5 wt %, 0.1-3 wt %, or 0.15-2 wt %.

In some embodiments, the EPDM blocking layer 34 is prepared from a composition further comprising one or more fillers. In some embodiments, the rubber backing composition comprises one or more fillers selected from carbon black, silica, silicates, talc, aluminum silicate, calcium carbonate, zinc oxide, titanium dioxide. In some embodiments, the composition comprises filler in an amount from about 30-60 wt %, 35-55 wt %, or 40-50 wt % compared to the total weight of the composition. In some embodiments, the ethylene propylene diene monomer (EPDM) is low ethylene EPDM. In some embodiments, the low ethylene EPDM has no more than 60% ethylene. An exemplary EPDM composition used in one embodiment of the blocking layer 34 is shown in Table 2. A Banbury™ mixer (Farrel Corporation) may be used to mix the different rubber formulations, for example, according to ASTM D 3182-07.

In some embodiments, the EPDM blocking layer 34 is prepared from a composition comprising a peroxidic vulcanizing agent. In some embodiments, the peroxide is an organic peroxide. Examples of peroxides used in some embodiments include, for instance: dicumyl peroxide, di-t-butyl peroxide, and t-butyl cumyl peroxide, and commercial products, such as VUL-CUP® 40KE (a,a′-bis(tert-butylperoxy)diisopropylbenzene; Arkema Inc.); LUPEROX™ DC40P-SP2 (dicumyl peroxide extended on calcium carbonate and silica, Arkema Inc.) or VAROX® DCP-99 (bis(1-methyl-1-phenylethyl) peroxide, R.T. Vanderbilt). In some embodiments, the peroxide is present at about 0.1 wt % to about 5 wt %; at about 0.2 wt % to about 3 wt %; at about 0.3 wt % to about 1 wt % by weight of the composition. In some embodiments, a di-t-butyl peroxide, is employed in the composition.

In some embodiments, the EPDM blocking layer 34 is prepared from a composition comprising one or more plasticizers. Example plasticizers used in some embodiments include polymer based types, such as polybutene, or paraffinic oils such as Sunpar 2280 DLC-ATM (paraffinic process oil silicon dioxide blend plasticizer, Natrochem Inc.), Drakeol® mineral oil (white mineral oil, Calumet Penreco; Dallas, Tex.), PD-23 White Oil (white mineral oil, Sonneborn, Inc.; Tarrytown, N.Y.). In some embodiments, the plasticizer is present at from about 0.1 wt % to about 25 wt %; about 1 wt % to about 20 wt %; about 5 wt % to about 15 wt %; or from about 10 wt % to about 15 wt % by weight of the composition used to prepare the blocking layer.

In some embodiments, room temperature properties of the EPDM blocking layer 34 material include tensile strength of 1300 psi minimum; % Elongation of 150% minimum; 100% Modulus of 400 psi minimum; and Shore A Hardness of 70-80 by ASTM.

In some embodiments, the reinforcement layer 32 comprises a textile. Examples of suitable textiles for the reinforcement layer 32 include aramid, polyester braid, nylon, cotton, and rayon. In some embodiments, the reinforcement layer 32 is a discontinuous layer. In some embodiments, the reinforcement layer 32 is a discontinuous layer comprising a polyester braid, or aramid braid. In some embodiments, the reinforcement layer 32 is an aramid braid.

In some embodiments, the inner tube 30 comprises one or more layers including PTFE. The inner tube 30 may comprise one, two, three or more layers including polytetrafluoroethylene (PTFE). In some embodiments, the PTFE is ASTM D4895, Type I, Grade 4, Class B (ASTM D1457, Type III, Grade 2, Class B). In examples, the PTFE is T62 (Dupont™ Teflon® PTFE 62). In some embodiments, one or more layers of the inner tube 30 includes PTFE and 0-20 wt %, 0.5-10 wt %, 0.7-5.0 wt %, or 1-2 wt % of a filler. In one embodiment, the inner tube 30 consists of two layers including PTFE, as shown in FIG. 4. Referring to FIG. 4, in one embodiment, the PTFE inner tube 30 comprises an Inner Tube Liner-Conductive layer 42 and an outer Tube Jacket Layer 44. In one aspect, the Inner Tube Conductive Liner 42 comprises PTFE and a filler. In some aspects, the filler is selected from any filler of the disclosure. In some aspects, the filler is a carbon black filler. In some aspects, the filler is a carbon black filler in a range of 1-2 wt % of the total weight of a composition used to prepare the Inner Conductive layer 42. In another aspect, the Tube Jacket 44 comprises PTFE. In some embodiments, hoses were developed with various dimensions of polytetrafluoroethylene (PTFE) inner tube core 30, as shown in Table 1.

TABLE 1
Inner Tube 30 Dimensions.

| Hose | Total | | Core | Conductive Liner |
|---|---|---|---|---|
| Size | Wall | TIR | OD | Thickness |
| −4 | .045-.055 | .008 | .338″ +/− .007 | 0.0074 |
| −6 | .047-.059 | .008 | .453″ +/− .008 | 0.0076 |
| −8 | .057-.068 | .008 | .578″ +/− .008 | 0.0068 |
| −10 | .057-.068 | .008 | .665″ +/− .005 | 0.0066 |
| −12 | .063-.075 | .008 | .785″ +/− .010 | 0.0074 |
| −16 | .065-.075 | .008 | 1.055″ +/− .015 | 0.0074 |

In some embodiments, no adhesive is employed between the inner tube 30 and the blocking layer 34. In other embodiments, an adhesive may be employed such as an epoxy, resorcinol formaldehyde latex (RFL), or a moisture cure urethane (MCU).

In certain examples, the hydraulic hose further comprises an additional outer layer. In certain examples, the additional layer includes an Ultra High Molecular Weight Polyethylene (UHMW), for example, DeWal DW402BNC, to enhance abrasion resistance. In some embodiments, the UHMW cover layer comprises one, two, three, or more plies of from 0.001″ to 0.01″, 0.002″ to 0.008″, or 0.003″ to 0.005″ thick. In one aspect the UHMW cover comprises two plies of 0.004″ so the total thickness is 0.008″ thick.

To manufacture the hydraulic hose 24a, the inner tube 30 is initially extruded over a mandrel. If the inner tube 30 includes two or more layers, they can be co-extruded. Next, the hose reinforcing layer 32 is applied over the inner tube 30 on the mandrel. Subsequently, the blocking layer 34 is extruded or wrapped over the hose reinforcing layer 32 and the inner tube 30 on the mandrel. The assembly can be passed through a water cooling tank to help it set cool slightly. The hose assembly is then wrapped with a wrap tape (e.g., a nylon wrap tape) to maintain pressure between the layers and to ensure hose dimensional integrity. If a flexible mandrel is being used, the hose can then be coiled. The hose is then put into an autoclave for vulcanization and peroxide curing. Thereafter, the nylon wrap tape is removed and the mandrel is ejected from the hose using pressure. It will be appreciated that the hydraulic hose 24b can be manufactured in a similar manner except the blocking layer 34 is extruded or otherwise applied directly over the inner tube 30 and the hose reinforcing layer 32 is installed over the blocking layer 34.

### EXAMPLES

### Example 1. Hose Comprising PTFE Core Tube and EPDM Blocking Layer

A prototype hose was prepared according to the invention, comprising an inner PTFE tube 30 of size −4, an aramid braid reinforcing layer 32 and an EPDM based blocking layer 34 of thickness 0.02 inches. EPDM (KELTAN® 6750, Lanxess) was selected for use as the base thermoplastic elastomer polymer for use in the composition for preparation of blocking layer 34 of the hose. The EPDM properties included ethylene content of 51 wt % by ASTM D 3900, ENB content of 7.7 wt % by ASTM D 6047, and Mooney Viscosity ML (1+4) 125° C. of 60 MU by ISO 289. The composition for preparation of blocking layer 34 is shown in Table 2. The EPDM layer was peroxide cured in part to in order to maintain heat resistance upwards of 150° C., while simultaneously maintaining the low temperature integrity (brittleness good to −50° C.), TR-10 (good to −45° C.) and low compression set (good at −50° C.). The blocking layer composition contained EPDM, filler, plasticizer, vulcanizing agent, antioxidant, and curing agent as shown in Table 2.

TABLE 2
Composition for EPDM Blocking Layer.

| | | % | | |
|---|---|---|---|---|
| Chemical | PPH | Weight | Description | Notes: |
| Keltan 6750 | 100.00 | 34.63 | EPDM Polymer (51% | Low Ethylene EPDM |
| | | | Ethylene, ML(1 + 4) 125° C. | |
| | | | Mooney Viscosity of 60 | |
| | | | MU; ENB 7.7% | |
| N650 BLACK | 85.00 | 29.44 | Carbon black | Filler |
| PELLETIZED | | | | |
| N990 BLACK | 35.00 | 12.12 | Carbon black | Filler |
| HI-SIL 243LD | 10.00 | 3.46 | Silica | Filler |
| SUNPAR 2280 | 40.00 | 13.85 | Paraffinic plasticizer | Plasticizer |
| F-2000 STEARIC | 1.00 | 0.35 | Stearic acid | Processing Aid |
| ACID | | | | |
| ANTIOXIDANT | 1.50 | 0.52 | Polymerized 2,2,4- | Protects rubber |
| DQ | | | trimethyl-1,2- | against oxygen and |
| | | | dihydroquinoline | heat |
| MAGCHEM | 5.00 | 1.73 | Magnesium oxide | Curing agent and acid |
| HSA-10 | | | | scavenger |
| REDIMIX 9595 | 0.55 | 0.19 | 50% TAC (Triallyl | Curing Agent, |
| | | | Cyanurate) | Coagent for peroxide |
| | | | | cure systems |
| VUL-CUP 40KE | 1.50 | 0.52 | 40% a,a′-bis(tert- | Vulcanizing agent; |
| | | | butylperoxy) | free radical donor |
| | | | diisopropylbenzene | |
| SARET SR633 | 2.20 | 0.76 | Zinc Diacrylate | Metallic coagent for |
| | | | | cross-linking for |
| | | | | peroxide cured |
| | | | | elastomers |
| VAROX DBPH- | 7.00 | 2.42 | 2,5-Dimethyl-2,5-Di(t- | Scorch protected |
| 50-HP | | | butylperoxy) Hexane | peroxide for cross- |
| | | | | linking |

Samples were prepared from the composition, vulcanized and subjected to testing for physical properties.

### Example 2. Physical Properties

Physical properties of the EPDM blocking layer 34 material, including tensile strength (psi), % Elongation, 100% Modulus (psi) and Shore A Hardness, were measured according to ASTM D412.

In some embodiments, room temperature properties of the EPDM blocking layer 34 material according to Example 1 includes tensile strength of 1300 psi minimum; % Elongation of 150% minimum; 100% Modulus of 400 psi minimum; and Shore A Hardness of 70-80 when tested according to ASTM D412. Actual room Temperature properties are shown in Table 3.

TABLE 3
Room Temperature Properties (ASTM D412).

| | Tensile strength | % | 100% Modulus | Shore A |
|---|---|---|---|---|
| | (psi) | Elongation | (psi) | Hardness |
| Actual | 2166 | 244 | 881 | 75 |
| Production | 1300 min | 150 min | 400 min | 70-80 |
| Spec | | | | |

As shown in Table 3, the EPDM blocking layer 34 material of the prototype hose of Example 1 met specifications for the Room Temperature Properties.

Low temperature properties were measured. The material exhibited −50° C. Compression set of 9.70% by ISO 815 Type A. Low temperature brittleness was measured by ISO 812 for two sets of hose sections identified as sample 1 and sample 2. Five modified T-50 specimens were conditioned for 5 minutes in methanol. Results are shown in Table 4.

TABLE 4
Low Temperature Brittleness, ISO 812

| | Sample 1 | Sample 2 |
|---|---|---|
| Brittlepoint, ° C. | −60 | −54 |

High temperature properties were measured by ASTM D412 with a three minute exposure at 150° C. Results are shown as % change in physical properties in Table 5.

TABLE 5
% Change in Physical Properties at 150° C.

| | Tensile Strength (psi) | % Elongation |
|---|---|---|
| Actual | 17% | −21% |

A TR10 Retraction Test was performed on the EPDM blocking layer 34 material of Example 1 per ISO 2921. T10 was performed at −35° C. maximum. T30 was performed at −25° C. maximum per ISO2921. In general, the retraction rate is believed to correlate with low temperature flexibility of rubbers. Results are shown in Table 6.

TABLE 6
TR-10 Retraction Test.

| | |
|---|---|
| TR10, (° C.) | −45.0 |
| TR30, (° C.) | −34.0 |
| TR50, (° C.) | −26.0 |
| TR70, (° C.) | −15.0 |

As demonstrated in Example 2, a hydraulic hose comprising the EPDM blocking layer material according to the invention is capable of maintaining integrity at temperatures ranging from minus 50 degrees C. to positive 150 degrees C.

Various modifications and alterations of this disclosure will become apparent to those skilled in the art without departing from the scope and spirit of this disclosure, and it should be understood that the scope of this disclosure is not to be unduly limited to the illustrative examples as set forth herein.

1. The method of claim 10, wherein the hydraulic hose comprises:
the first layer having a composition that includes the PTFE; and
the second layer for preventing the alkyl phosphate ester from permeating through the hydraulic hose to an exterior surface of the hydraulic hose, the second layer having a composition that includes a low ethylene EPDM rubber.

2. The method of claim 1, wherein the low ethylene EPDM rubber has a formulation with less than 60% ethylene.

3. The hydraulic hose of claim 2, wherein the low ethylene EPDM rubber has a formulation with 50-60% ethylene.

4. The method of claim 1, wherein the hydraulic hose maintains integrity at temperatures ranging from minus 50 degrees C. to positive 150 degrees C.

5. The method of claim 1, wherein the second layer is peroxide cured.

6. The method of claim 1, wherein the second layer is positioned outside the first layer and surrounds the first layer.

7. The method of claim 1, further comprising a hose reinforcing layer that includes reinforcing elements.

8. The method of claim 7, wherein the hose reinforcing layer is positioned between the first layer and the second layer.

9. The method of claim 6, wherein the second layer is positioned between the first layer and the hose reinforcing layer.

10. A method for preventing an alkyl phosphate ester from permeating through a hydraulic hose having a polytetrafluoroethylene (PTFE) first layer, the method comprising:
containing the alkyl phosphate ester that permeates through the PTFE first layer at a location between the PTFE first layer and a blocking second layer that surrounds the PTFE first layer, wherein the blocking second layer has a composition that includes an EPDM rubber.

11. (canceled)

12. The method of claim 1, wherein the composition of the second layer that includes the low ethylene EPDM rubber exhibits one or more of the following properties by ASTM D412 following vulcanization: a) minimum tensile strength of 1300 psi; b) minimum % Elongation of 150%; c) minimum 100% Modulus of 400 psi; and d) Shore A Hardness of 70-80.

13. The method of claim 1, wherein the composition of the second layer comprises one or more EPDM polymers in a range of from 20-50 wt %, 25-45 wt %, or 30-40 wt %.

14. The method of claim 1, wherein the composition of the second layer comprises an EPDM polymer comprising ethylidene norbornene (ENB) in the range of 5-10 wt %, 6-9 wt % or 7-8 wt %.

15. The method of claim 1, wherein the composition of the second layer comprises a filler selected from the group consisting of carbon black, silica, silicates, talc, aluminum silicate, calcium carbonate, zinc oxide, and titanium dioxide.

16. The method of claim 15, wherein the composition of the second layer comprises a filler in a range of from 30-60 wt %, 35-55 wt %, or 40-50 wt % compared to the total weight of the composition.

17. The method of claim 1, wherein the first layer, having a composition that comprises PTFE, comprises an inner conductive layer and an outer tube jacket.

18. The method of claim 17, wherein one or both of the inner conductive layer and the outer tube jacket comprise PTFE and a filler.

19. The method of claim 1, wherein the hydraulic hose further comprises an additional outer layer having one, two, three, or more plies prepared from a composition comprising an Ultra High Molecular Weight Polyethylene (UHMW).

20. The method of claim 10, wherein the alkyl phosphate ester is an aviation hydraulic fluid.

21. The method of claim 10, wherein the hydraulic hose is suitable for conveying the alkyl phosphate ester in aerospace applications.

22. The method of claim 2, wherein the low ethylene EPDM rubber has a formulation with 45-55 wt % ethylene by ASTM D 3900.
